(19) United States
(12) Patent Application Publication
(10) Pub. No.: US 2018/0243809 A1
(43) Pub. Date: Aug. 30, 2018

(54) ELECTRIC RESISTANCE WELDED STAINLESS CLAD STEEL PIPE AND METHOD OF MANUFACTURING THE SAME

(71) Applicant: JFE STEEL CORPORATION, Tokyo (JP)

(72) Inventors: Takatoshi Okabe, Handa (JP); Sota Goto, Kawasaki (JP); Yuji Hashimoto, Handa (JP); Yasushi Kato, Handa (JP); Atsushi Matsumoto, Handa (JP); Shinsuke Ide, Handa (JP); Hiroki Ota, Handa (JP)

(73) Assignee: JFE STEEL CORPORATION, Tokyo (JP)

(21) Appl. No.: 15/557,374

(22) PCT Filed: Feb. 18, 2016
(86) PCT No.: PCT/JP2016/000850

§ 371 Date: Sep. 11, 2017

(30) Foreign Application Priority Data
Mar. 12, 2015 (JP) 2015-048966

(51) Int. Cl. B21C 37/08; B23K 11/06; B23K 11/087

(52) U.S. Cl. CPC B21C 37/08; B23K 11/36; B23K 11/0873; B23K 11/062

(57) ABSTRACT

Provided are an electric resistance welded stainless clad steel manufactured by forming a hot-rolled steel strip of clad steel including low-carbon low-alloy steel and stainless steel into a cylindrical shape, and electric resistance welding the edges of the hot-rolled steel strip, characterized in that the flattening characteristic of an electric resistance weld, as-welded, satisfies the formula h/D<0.3, wherein h is the flattened height at fracture (mm) and D is the outer diameter of the pipe (mm), and a method of manufacturing the same.

### CROSS REFERENCE TO RELATED APPLICATIONS

This is the U.S. National Phase application of PCT/JP2016/000850, filed Feb. 18, 2016, which claims priority to Japanese Patent Application No. 2015-048966, filed Mar. 12, 2015, the disclosures of these applications being incorporated herein by reference in their entireties for all purposes.

### TECHNICAL FIELD OF THE INVENTION

The present invention relates to an electric resistance welded stainless clad steel pipe and a method of manufacturing the same, and more particularly relates to an electric resistance welded stainless clad steel pipe which, as-welded, has excellent weld characteristics and a method of manufacturing the same.

### BACKGROUND OF THE INVENTION

In general, an electric resistance welded steel pipe is manufactured by a method in which a steel sheet (also referred to as a “steel strip”) is formed into a cylindrical shape, and the opposing edges in the width direction of the steel strip are heated and melted by a high-frequency current and butt-welded together by applying pressure with squeeze rolls. Electric resistance welded steel pipes are generally thought to have poorer characteristics in the weld than in the base metal. In using the welded steel pipes, there has been controversy over how to ensure characteristics, such as high toughness, strength, and elongation, of the weld for each application.

The characteristics of the electric resistance weld are often deteriorated by penetrators, which are weld defects including mainly oxides, that are formed and remain in the portions to be welded (i.e., butting edges of an open pipe, in which the two end surfaces in the circumferential direction of the open pipe formed by rounding a steel strip face each other) during electric resistance welding. These remaining penetrators result in low toughness and insufficient strength.

Accordingly, in existing techniques, in order to remove penetrators, which are the major cause of electric resistance welding defects, from the weld, by setting the amount of upset due to squeeze rolls to be larger than the thickness (t), oxide melts occurring during welding are discharged to the outside of the pipe.

However, in the case where an electric resistance welded clad steel pipe is manufactured by using a clad steel sheet as a material, when the amount of upset due to squeeze rolls is set to be larger than the thickness (t), as shown in FIG. 6(a), a phenomenon occurs in which molten steel and the heat-affected zone of plain steel, which is a base metal, penetrate into the metal seam portion of the cladding material disposed inside or outside or on each side of the base metal, resulting in a loss of performance of the clad steel which makes good use of excellent characteristics of the cladding material. For example, in the case where a stainless clad steel sheet, in which the cladding material on the pipe inner-surface side is stainless steel and the base metal on the pipe outer-surface side is low-alloy steel, is used as a material, and an electric resistance welded stainless clad steel pipe is obtained by electric resistance welding with setting the amount of upset to be larger than the thickness (t) as described above, when the electric resistance welded stainless clad steel pipe is used in an environment where corrosion resistance is required on the inner surface of the pipe, the performance requirement cannot be satisfied because the corrosion resistance of the seam portion of stainless steel is markedly deteriorated owing to penetration of low-alloy steel, which is a problem. The term “clad steel” refers to clad steel including low-carbon low-alloy steel serving as a base metal and stainless steel serving as a cladding material.

In order to overcome such a problem, Patent Literature 1 discloses a method of producing a clad pipe in which two opposing edges of a rounded clad steel sheet or steel strip are subjected to butt welding, at least beads on the cladding material side among weld beads are cut away down to the depth reaching the base metal, and the cut-away portion is subjected to build-up welding with a material having the same properties as the cladding material.

Furthermore, Patent Literature 2 discloses a method of producing a clad steel pipe in which a clad steel strip is formed into an open pipe; the seam edge portion is subjected to electric resistance welding; and then, by melting and solidifying dissimilar metal up to the depth of a clad interface along the welding seam into which the dissimilar metal has penetrated, the dissimilar metal is diluted, or by subjecting the seam portion, into which dissimilar metal has penetrated, to build-up welding with the same metal as the cladding material and by rolling the built-up weld, the dissimilar metal is diluted.

Furthermore, Patent Literature 3 discloses a method of producing a welded clad steel pipe including a cladding material on the inner-surface side, in which an original sheet or original coil of clad steel is formed into a cylindrical body including a cladding material on the inner-surface side, at least part of butting portions of the cladding material of the cylindrical body is subjected to electric resistance welding, and then unwelded butting portions are subjected to build-up welding.

### Patent Literature

PTL 1: Japanese Unexamined Patent Application Publication No. 60-221173

PTL 2: Japanese Unexamined Patent Application Publication No. 62-156087

PTL 3: Japanese Unexamined Patent Application Publication No. 5-154545

### SUMMARY OF THE INVENTION

However, the techniques described in Patent Literature 1 to 3 each require, after electric resistance welding, an additional welding process, such as cutting away cladding material beads and performing build-up welding (Patent Literature 1), melting and solidifying with a TIG arc heat source or build-up welding along the weld seam portion (Patent Literature 2), or build-up welding the unwelded butting portions (Patent Literature 3). Therefore, productivity is decreased, the production cost is increased, and the additional build-up welding badly affects the environment, all of which are problems.

In certain embodiments of the present invention an electric resistance welded stainless clad steel pipe which has excellent weld characteristics, even without performing an additional welding process that is required in existing techniques after electric resistance welding, and a method of manufacturing the same, is provided.

The excellent weld characteristics include mainly excellent fracture characteristics, good weld shape, and excellent corrosion resistance.

It has been determined, in the case where a shielding gas is blown over portions to be welded of an open pipe from directly above the portions to be welded in the region extending from the heating starting point to the welding point at the edges of the open pipe without covering the above region with a shield box, the oxygen concentration around the portions to be welded can be markedly decreased by properly controlling the nozzle height i.e., the height from the upper ends of the portions to be welded to a shielding-gas outlet of a shielding-gas blowing nozzle, as well as the flow rate of the shielding gas to be blown; and also by configuring the shielding-gas blowing nozzle to be divided into three or more layers in the circumferential direction of the open pipe and by properly controlling the ratio between the flow rate of the blown gas at the gas outlet of two side layers and the flow rate of the blown gas at the gas outlet of the remaining layers.

Accordingly, a test was conducted as described below. A stainless clad steel sheet including a cladding material made of stainless steel (SUS316) with a thickness of 2 mm on the pipe inner-surface side and a base metal made of low-carbon low-alloy steel with a thickness of 5 mm on the pipe outer-surface side was used as a material. Electric resistance welded stainless clad steel pipes were produced by varying the oxygen concentration around the portions to be welded, as shown in FIG. 6(b), with the amount of upset being set to be smaller than the thickness such that the low-alloy steel on the pipe outer-surface side did not penetrate the seam portion of the stainless steel on the pipe inner-surface side. Subsequently, a flattening test was conducted on the seam portion. As a result, as shown in FIG. 5, in the electric resistance welded stainless clad steel pipes produced in an atmosphere in which the oxygen concentration around the portions to be welded was 0.01% by mass or less, the flattening ratio h/D (h: flattened height at fracture, D: outer diameter of pipe) was less than 0.3 in the 90° flattening test, revealing that the weld had excellent fracture characteristics.

Embodiments of the present invention are as follows:

[1] An electric resistance welded stainless clad steel pipe made of clad steel including low-carbon low-alloy steel and stainless steel, wherein the flattening characteristic of an electric resistance weld, as-welded, satisfies formula (1):

h/D<0.3 (1)

wherein h is the flattened height at fracture (mm) and D is the outer diameter of the pipe (mm).

[2] The electric resistance welded stainless clad steel pipe according to item [1], wherein the thickness tw of the electric resistance weld satisfies formula (2):

0.7×tb<tw<1.6×tb (2)

wherein tb is the thickness of base metal (mm) and tw is the thickness of the weld (mm).

[3] A method of manufacturing the electric resistance welded stainless clad steel pipe according to item [1] or [2], wherein a shielding process for portions of an open pipe to be welded for an electric resistance welded steel pipe is used to shield portions to be welded with a shielding gas composed of an inert gas during the electric resistance welding, the method including blowing the shielding gas to the portions to be welded through a gas outlet of a shielding-gas blowing nozzle which is divided into three layers in the open pipe circumferential direction, the gas outlet being disposed at a position 5 to 300 mm above the upper ends of the portions to be welded. The gas flow, rate B at the gas outlet of a center layer among the three layers is set to be 0.5 to 50 m/s, and the gas flow rate A (m/s) at the gas outlet of the remaining two side layers is set so as to satisfy formula (3):

0.01≤B/A≤10 (3)

[4] In the method of manufacturing the electric resistance welded stainless clad steel pipe according to item [3], the gas outlet is rectangular and has a length of 30 mm or more in a pipe-length direction and a width of 5 mm or more in a direction in which open pipe edges face each other.

[5] In the method of manufacturing the electric resistance welded stainless clad steel pipe according to item [3] or [4], the relationship R/W>1.0 is satisfied, wherein R is the total width of all the layers combined at the gas outlet in the direction in which open pipe edges face each other, and W is the maximum distance between end surfaces of the portions to be welded directly below the gas outlet.

[6] In the method of manufacturing the electric resistance welded stainless clad steel pipe according to any one of items [3] to [5], the inert gas is replaced by a gas containing 0.1% by mass or more of a reducing gas.

According to embodiments of the present invention, it is possible to manufacture an electric resistance welded stainless clad steel pipe which has excellent weld characteristics, even without performing an additional welding process that is required in existing techniques after electric resistance welding.

### BRIEF DESCRIPTION OF THE DRAWINGS

FIG. 1 includes schematic views showing an embodiment of the present invention.

FIG. 2 includes schematic views showing examples of a nozzle structure which is divided into a plurality of layers.

FIG. 3 includes views illustrating the gas flow rate B of a shielding gas and the proper range of the gas flow rate ratio B/A.

FIG. 4 is a graph showing the relationship between the gas flow rate ratio B/A of a shielding gas and the oxygen concentration around portions to be welded (butting edges of an open pipe).

FIG. 5 is a graph showing the relationship between the flattening ratio h/D in the 90° flattening test of electric resistance welded stainless clad steel pipes and the oxygen concentration around portions to be welded (butting edges of an open pipe).

FIG. 6 includes schematic views showing cross sections of welds of electric resistance welded stainless clad steel pipes, in which the cladding material on the pipe inner-surface side is stainless steel and the base metal on the pipe outer-surface side is low-alloy steel, produced by electric resistance welding with different amounts of upset.

### DETAILED DESCRIPTION OF THE INVENTION

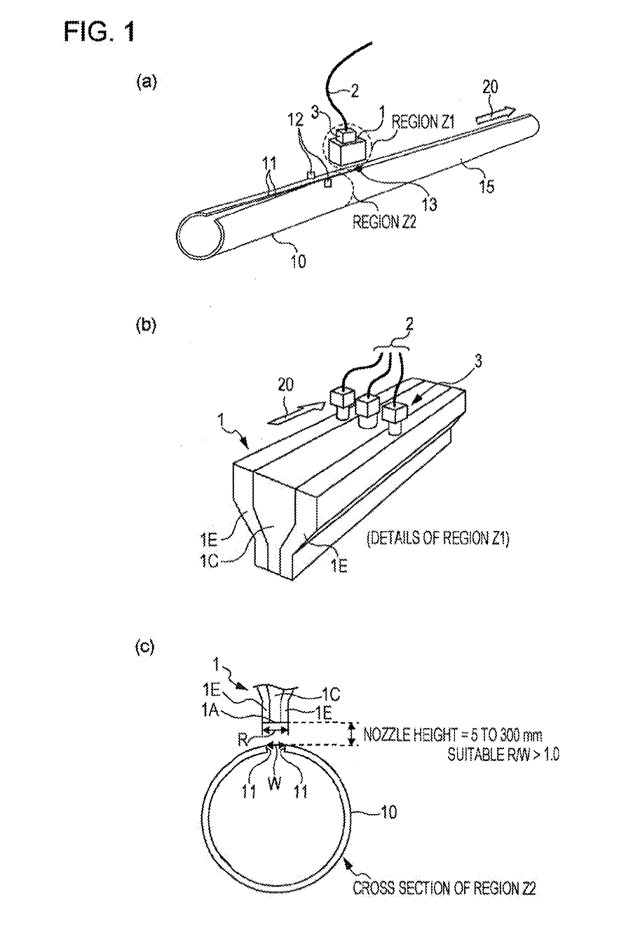

FIG. 1 includes schematic views showing an embodiment of the present invention. A steel strip is continuously fed from an uncoiler (not shown) and is corrected with a leveler (not shown). While the steel strip is being conveyed in the pipe-length direction 20, the strip is rounded in the width direction into an open pipe 10 by a roll former (not shown). Portions to be welded (11), i.e., butting edges of the open pipe, in which the two end surfaces of the strip rounded in the width direction face each other, are electric resistance welded together by an electric resistance welding machine, which includes a power supply device for heating edges (not shown) and squeeze rolls for pressure welding (not shown), to obtain an electric resistance welded steel pipe 15. Reference sign 12 denotes a heating starting point at the edge of the open pipe, and reference sign 13 denotes a welding point corresponding to a position in the pipe-length direction at which the portions to be welded (11) are welded together by the pressure welding. In some cases, an impeder (not shown) may be disposed on the pipe inner-surface side of the open pipe 10 or the electric resistance welded steel pipe 15. After the electric resistance welded steel pipe 15 has left the electric resistance welding machine, the outer diameter thereof is adjusted by a sizer (not shown). In FIG. 1, reference sign 2 denotes a gas tube, and reference sign 3 denotes a gas controller.

In embodiments of the present invention, a shielding range is defined in the entire region extending in the pipe-length direction from the heating starting points 12 at the edges of the open pipe to the welding point 13, or in a zone within the region where oxides are likely to be formed on the portions to be welded (this zone can be specified by preliminary study). In the shielding range, a shielding-gas blowing nozzle (abbreviated as “nozzle”) 1 is disposed at a position directly above the portions to be welded (11).

The nozzle 1 is disposed such that a gas outlet 1A directly faces the upper ends of the portions to be welded (11).

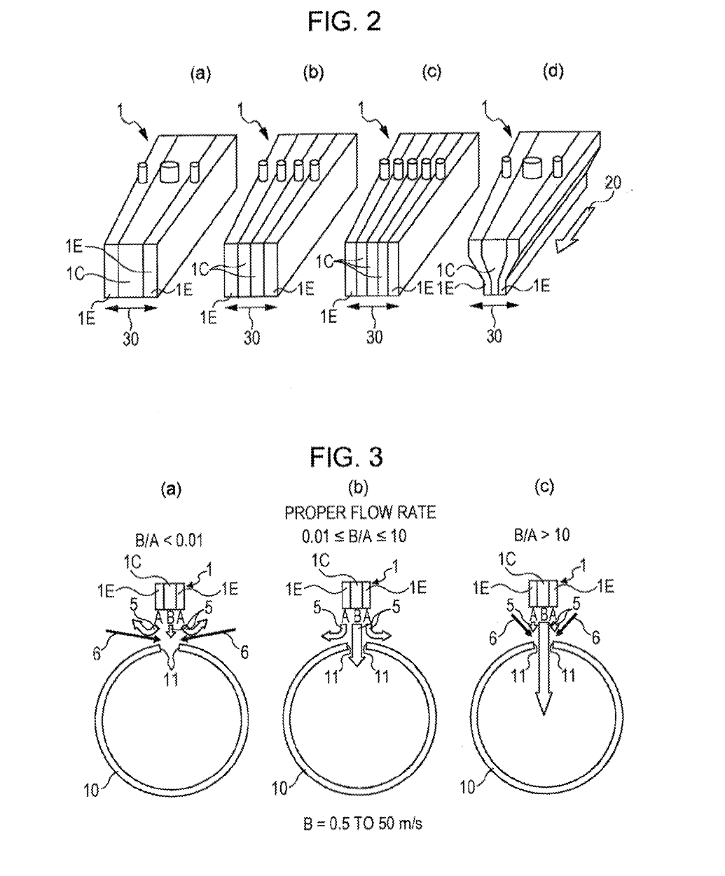

In embodiments of the present invention, the nozzle 1 is divided into three layers in the open pipe circumferential direction, as shown in FIG. 1(b) and FIGS. 2(a) and 2(d). These layers constitute gas flow channels which are independent from each other. Furthermore, a center layer 1C among the three layers may be divided into two or more layers in the open pipe circumferential direction 30, as shown in FIGS. 2(b) and 2(c). Side layers 1E are each a single layer.

In embodiments of the present invention, a shield box that covers the circumference of the open pipe 10 in the shielding range, to which reference is made in the background art, may not be provided. It is preferable not to include a shield box from the viewpoint of the pipe-making efficiency and production cost for electric resistance welded steel pipes, and therefore, the shield box is not provided in this embodiment.

The flow of the shielding gas has been observed in detail. The influence of various shielding gas blowing conditions, such as the position and size of the gas outlet 1A and the flow rate of the shielding gas at the gas outlet 1A of each of the center layer 1C and the side layers 1E, on the oxygen concentration around the portions to be welded (11) during electric resistance welding and the oxide area fraction in the weld formed by electric resistance welding between the portions to be welded has also been examined in detail.

As a result, it has been determined, when the shielding gas blowing conditions are optimized, the oxygen concentration around the portions to be welded is 0.01% by mass or less, and the oxide area fraction in the weld is less than 0.1%. The oxide area fraction in the weld is determined as follows: A fracture surface formed by subjecting an electric resistance weld to a Charpy impact test is observed in at least ten fields of view with an electron microscope at a magnification of 500 times or more. Oxide-containing dimple fracture surface areas observed in the fracture surface are selected, and the total area thereof is measured. The ratio of the total area of the oxide-containing dimple fracture surface areas to the total area of the fields of view is defined as the oxide area fraction.

The optimum conditions which have been determined are as follows: The nozzle height, i.e., the height from the upper ends of the portions to be welded (11) to the gas outlet 1A, is 5 to 300 mm (refer to FIG. 1(c)). The flow rate B of the shielding gas 5 at the gas outlet 1A of the center layer 1C is 0.5 to 50 m/s, and the flow rate A of the shielding gas 5 at the gas outlet 1A of the side layers 15 satisfies the formula 0.01≤B/A≤10 (refer to FIG. 3).

When the nozzle height exceeds 300 mm, the shielding gas does not sufficiently reach the portions to be welded (11), and the oxygen concentration around the portions to be welded (11) does not become 100 ppm or less. A smaller nozzle height is desirable. However, when the nozzle height is less than 5 mm, the gas outlet 1A is likely to be damaged by radiation heat from the heated portions to be welded (11), and spatters produced in the portions to be welded (11) strike the nozzle 1, thus deteriorating the durability of the nozzle 1.

In order to control the flow rate within the range of the above-mentioned optimum conditions, in embodiments of the present invention, a gas controller 3 (refer to FIGS. 1(a) and 1(b)) is used, in which regarding the flow rate of the shielding gas blown through the gas outlet, the gas flow rate B at the gas outlet of the center layer 1C among the three layers is controlled to be 0.5 to 50 m/s, and the gas flow rate A at the gas outlet of the remaining two side layers 1E is controlled so as to satisfy the formula 0.01≤B/A≤10.

When the flow rate B is excessively low, the shielding gas spreads out and the portions to be welded (11) are insufficiently shielded with the gas. When the flow rate B is excessively high, the force of the shielding gas increases excessively, resulting in occurrence of air entrainment between the end surfaces of the portions to be welded (11). Therefore, the proper range of the flow rate B is 0.5 to 50 m/s. In the case where the center layer C is further divided into a plurality of layers (e.g., FIGS. 2(b) and 2(c)), the plurality of layers do not necessarily have the same flow rate B, and the flow rate may vary depending on the layer as long as it is within the proper range described above.

However, even when the flow rate B is maintained within the proper range, if the gas flow rate ratio B/A, i.e., the ratio of the flow rate B to the flow rate A, is inappropriate, it is difficult to prevent air entrainment 6 as shown in FIG. 3.

That is, in the case where B/A<0.01, the gas flow (flow of the shielding gas 5) from the side layers 15 is excessively strong, and the gas flow from the center layer 1C is excessively weak. Consequently, the gas flow from the side layers 15 is reflected by the outer surface of the open pipe 10 and deflected upward, and the gas flow rate in the reflection region becomes close to zero. Therefore, it is not possible to prevent air entrainment 6 along the outer surface of the open pipe 10 (refer to FIG. 3(a)), and the oxygen concentration around the portions to be welded (11) cannot be decreased sufficiently.

On the other hand, in the case where B/A>10, the gas flow from the center layer 1C is excessively strong, and the gas flow from the side layers 15 is excessively weak. Consequently, the air is drawn between the end surfaces of the portions to be welded (11) by the gas flow from the center layer 1C, which is likely to cause air entrainment 6 (refer to FIG. 3(c)). Therefore, the oxygen concentration around the portions to be welded (11) cannot be decreased sufficiently.

In contrast, by setting the ratio B/A to be 0.01 to 10, the shielding gas 5, neither excessively nor insufficiently, fills the space between the end surfaces of the portions to be welded (11) without causing air entrainment, and thus sufficient gas shielding can be achieved (refer to FIG. 3(b)). Regarding the flow rate B in the gas flow rate ratio B/A, in the case where the center layer 1C is divided into a plurality of layers, and at least one layer of the plurality of layers has a gas flow rate different from that of the other layers, the maximum flow rate among different gas flow rates is used.

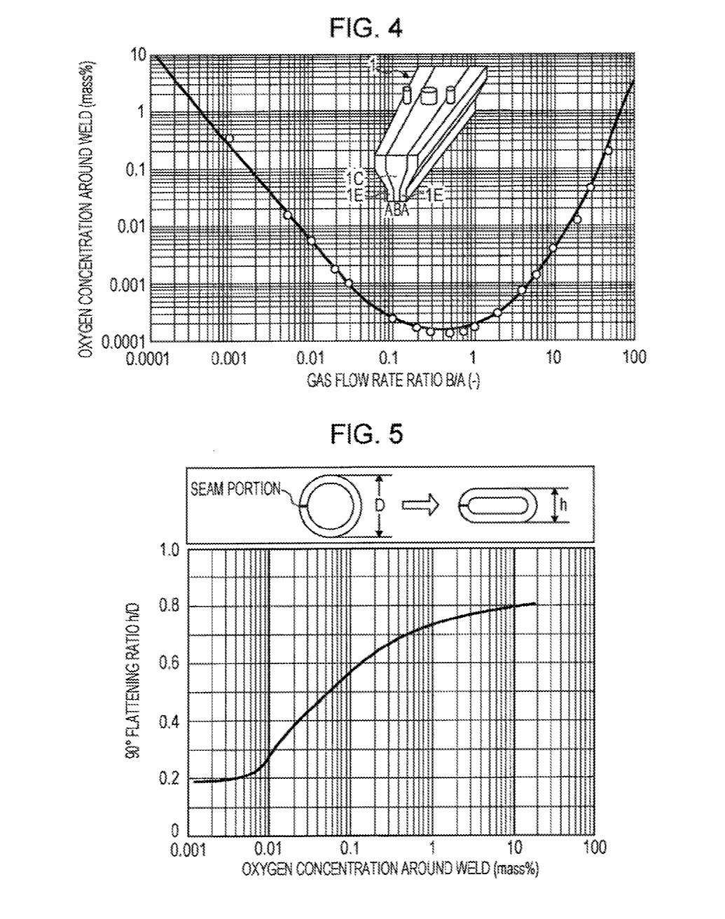

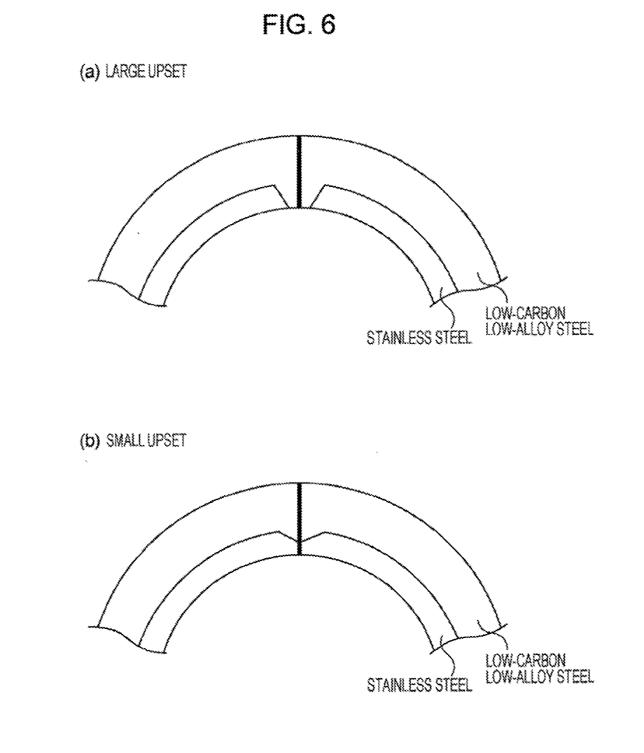

FIG. 4 is a graph showing, as an example, the results obtained by measuring the oxygen concentration at the middle position between the end surfaces of the portions to be welded (11) in the case where the shielding gas 5 is blown over the portions to be welded (11) by setting the nozzle height to be 50 mm and varying the gas flow rate ratio B/A in the proper range of the flow rate B of 0.5 to 50 m/s.

As is evident from FIG. 4, by setting the gas flow rate ratio B/A to be 0.01 to 10 in the proper range of the flow rate B of 0.5 to 50 m/s, it is possible to achieve an oxygen concentration of 0.01% by mass or less with a large margin (i.e., reliably).

Furthermore, as is evident from FIG. 4, by setting the gas flow rate ratio B/A to be 0.03 to 5, it is possible to achieve a lower oxygen concentration level, i.e., 0.001% to 0.0001% by mass, which is preferable. It has been confirmed that this result can be obtained even when other conditions, such as the nozzle height, are changed. That is, in embodiments of the present invention, it is preferable to set the ratio B/A to be 0.03 to 5 from the viewpoint of achieving an oxygen concentration level of 0.001% to 0.0001% by mass.

By configuring the gas outlet 1A in which all the layers are combined to be rectangular in shape and to have a length of 30 mm or more in a pipe-length direction 20 and a width of 5 mm or more in a direction in which open pipe edges face each other, the gas can be more uniformly blown over the portions to be welded (11), which is preferable.

Furthermore, as shown in FIG. 1(c), when the relationship R/W>1.0 is satisfied, where R is the total width of all the layers combined at the gas outlet 1A in the direction in which open pipe edges face each other, and W is the maximum distance between end surfaces of the portions to be welded (11) directly below the gas outlet 1A, the oxygen concentration around the portions to be welded (11) can be more rapidly decreased, which is preferable.

As the shielding gas, an inert gas is used. As used herein, the term “inert gas” refers to a gas, such as nitrogen gas, helium gas, argon gas, neon gas, or xenon gas, or a mixture of two or more of these gases.

Furthermore, as the shielding gas, the inert gas may be replaced by a gas containing 0.1% by mass or more of a reducing gas. The gas containing 0.1% by mass or more of a reducing gas is preferred because it is more effective in suppressing the formation of oxides, which are the cause of penetrators, and it can more greatly improve the toughness or strength of the weld. As used herein, the term “reducing gas” refers to a gas, such as hydrogen gas, carbon monoxide gas, methane gas, or propane gas, or a mixture of two or more of these gases. Preferably, the gas containing 0.1% by mass or more of a reducing gas is a gas composed of only a reducing gas, or a gas containing 0.1% by mass or more of a reducing gas and the balance being an inert gas.

From the viewpoint of availability and low cost, the following gases are preferable as the shielding gas to be used:

(a) In the case where an inert gas is used alone: (G1) any one of nitrogen gas, helium gas, and argon gas, or a mixture of two or more of these gases.

(b) In the case where a reducing gas is used alone: (G2) one of hydrogen gas and carbon monoxide gas or a mixture of these two gases.

(c) In the case where a mixture of an inert gas and a reducing gas is used: a mixture of the gases (G1) and (G2).

In particular, in the case where a gas containing hydrogen gas and/or carbon monoxide gas is used, sufficient safety measures should be taken without omission.

The amount of upset is determined by measuring the circumference of the pipe immediately before welding, then measuring the circumference of the welded pipe after excess weld metal is removed, and calculating the difference between the two measured values.

The electric resistance welded steel pipe (electric resistance welded stainless clad steel pipe) 15 according to embodiments of the present invention obtained as described above is made of clad steel including low-carbon low-alloy steel and stainless steel. The flattening characteristic of an electric resistance weld, as-welded, satisfies the formula (1) below, and the electric resistance welded steel pipe has the electric resistance weld having excellent fracture characteristics:

h/D<0.3 (1)

where h is the flattened height at fracture (mm) and D is the outer diameter of the pipe (mm).

The flattening characteristics can be measured by a 90° flattening test. A pipe is cut to a length of 300 mm, and then placed such that the weld is located at the position 90° relative to the vertical at the top of the pipe (0°). The flattening test is conducted, and the flattened height at the time when fracture occurs (flattened height at fracture h) is divided by the outer diameter of pipe D to obtain the flattening ratio.

Furthermore, when the thickness tw (mm) of the electric resistance weld is 0.7×tb (mm) or less, the strength of the electric resistance weld may be deteriorated in some cases. Therefore, the thickness tw is preferably more than 0.7×tb. Furthermore, when the thickness tw (mm) of the electric resistance weld is 1.6×tb or more, a gap may be formed between welds during circumferential welding between pipes to deteriorate corrosion resistance in some cases. Therefore, the thickness tw is preferably less than 1.6×tb. Consequently, the thickness tw preferably satisfies the formula (2) below:

0.7×tb<tw<1.6×tb (2)

where tb is the thickness of base metal (mm) and tw is the thickness of the weld (mm).

### EXAMPLE 1

Electric resistance welded stainless clad steel pipes with an outer diameter of 300 mm were manufactured by a method in which stainless clad steel sheets including a cladding material made of stainless steel (SUS316, SUS304, SUS310, or SUS429) with a thickness of 2 mm on the pipe inner-surface side and a base metal made of low-carbon low-alloy steel (0.05 mass % C-0.3 mass % Si-1.2 mass % Mn—Fe) with a thickness of 5 mm on the pipe outer-surface side were used as a material, and the stainless clad steel sheets were passed through a pipe-making system including an uncoiler, a leveler, a roll former, an electric resistance welding machine, and a sizer arranged in this order. In the manufacturing process, during electric resistance welding, gas shielding for portions to be welded was performed by varying level of the gas blowing conditions and the amount of upset within or outside the ranges of embodiments of the present invention described in the embodiment as shown in Tables 1 and 2. The thickness tb (mm) of the base metal and the thickness tw (mm) of the electric resistance weld were measured. The oxygen concentration around portions to be welded was measured. A 90° flattening test was conducted on the weld, and a corrosion test by oxalic acid etching was conducted on the inner-surface side of the pipe. As the reducing gas, 3% by mass hydrogen gas was used. The amount of upset due to squeeze rolls was determined by measuring the circumference of the pipe before being subjected to squeeze rolls, then measuring the circumference of the pipe after welding was performed with squeeze rolls and molten beads on the outer surface were cut away, and calculating the difference between the two measured values. The thickness of the base metal was determined by measuring the thickness of the pipe at a pitch of 60° in the circumferential direction of the pipe, relative to the weld (0°), i.e., at positions of 60°, 120°, 180°, 240°, and 300°, and calculating the average value thereof. The thickness of the weld was determined by measuring the thickness of the weld seam portion.

In the corrosion test, the pipe in which intergranular corrosion was not observed was evaluated as pass, and the pipe in which intergranular corrosion was observed was evaluated as rejection.

As shown in Tables 1 and 2, it has been confirmed that, in the inventive examples, the flattening ratio h/D (h: flattened height at fracture (mm), D: outer diameter of pipe (mm)) of the weld is significantly low compared with the comparative examples, the fracture characteristics are excellent, the weld has a good shape, and the weld maintains corrosion resistance of the stainless steel.

TABLE 1

| | | | | | | | | Oxygen | | | | | | |
|---|---|---|---|---|---|---|---|---|---|---|---|---|---|---|
| | | | | | | | | concentration | | | | | | |
| | | | | Gas | | | | around | Results | | | | | |
| | | | Gas | flow | | | | portions | of | Thick- | Thick- | | Results of | |
| | | | flow | rate | | Reducing | | to be | flattening | ness | ness | | corrosion | |
| | | Nozzle | rate B | ratio | | gas | Amount | welded | test on | of base | of | | test on | |
| | Cladding | height | (m/s) | B/A | R/W | content | of upset | (mass | weld | metal tb | weld tw | | pipe inner | |
| Level | material | (mm) | *1 | *1 | *2 | (mass %) | (mm) | % × 10²) | h/D | (mm) | (mm) | tw/tb | surface | Remarks |
| 1 | SUS316 | 100 | 0.5 | 0.5 | 5.0 | None | 4 | 0.03 | 0.2 | 7.0 | 7.5 | 1.1 | Pass | Inventive |
| | | | | | | | | | | | | | | example |
| 2 | SUS316 | 100 | 1.0 | 0.5 | 5.0 | None | 4 | 0.04 | 0.1 | 7.0 | 7.5 | 1.1 | Pass | Inventive |
| | | | | | | | | | | | | | | example |
| 3 | SUS316 | 100 | 5.0 | 0.5 | 5.0 | None | 4 | 0.02 | 0.1 | 7.0 | 7.5 | 1.1 | Pass | Inventive |
| | | | | | | | | | | | | | | example |
| 4 | SUS316 | 100 | 10.0 | 0.1 | 5.0 | None | 4 | 0.04 | 0.1 | 7.0 | 7.5 | 1.1 | Pass | Inventive |
| | | | | | | | | | | | | | | example |
| 5 | SUS316 | 100 | 50.0 | 0.03 | 5.0 | None | 4 | 0.06 | 0.1 | 7.0 | 7.5 | 1.1 | Pass | Inventive |
| | | | | | | | | | | | | | | example |
| 6 | SUS316 | 200 | 0.5 | 3 | 5.0 | None | 4 | 0.08 | 0.1 | 7.0 | 7.5 | 1.1 | Pass | Inventive |
| | | | | | | | | | | | | | | example |
| 7 | SUS316 | 200 | 1.0 | 2 | 5.0 | None | 4 | 0.09 | 0.1 | 7.0 | 7.5 | 1.1 | Pass | Inventive |
| | | | | | | | | | | | | | | example |
| 8 | SUS316 | 200 | 5.0 | 10 | 5.0 | None | 4 | 0.3 | 0.2 | 7.0 | 7.5 | 1.1 | Pass | Inventive |
| | | | | | | | | | | | | | | example |
| 9 | SUS316 | 200 | 10.0 | 0.01 | 5.0 | None | 4 | 0.2 | 0.2 | 7.0 | 7.5 | 1.1 | Pass | Inventive |
| | | | | | | | | | | | | | | example |
| 10 | SUS316 | 200 | 50.0 | 0.05 | 5.0 | None | 4 | 0.1 | 0.2 | 7.0 | 7.5 | 1.1 | Pass | Inventive |
| | | | | | | | | | | | | | | example |
| 11 | SUS316 | 50 | 0.5 | 0.5 | 5.0 | None | 4 | 0.1 | 0.2 | 7.0 | 7.5 | 1.1 | Pass | Inventive |
| | | | | | | | | | | | | | | example |
| 12 | SUS316 | 50 | 1.0 | 3 | 5.0 | None | 4 | 0.07 | 0.2 | 7.0 | 7.5 | 1.1 | Pass | Inventive |
| | | | | | | | | | | | | | | example |
| 13 | SUS316 | 50 | 5.0 | 0.2 | 5.0 | None | 4 | 0.04 | 0.1 | 7.0 | 7.5 | 1.1 | Pass | Inventive |
| | | | | | | | | | | | | | | example |
| 14 | SUS316 | 50 | 10.0 | 0.3 | 5.0 | None | 4 | 0.05 | 0.1 | 7.0 | 7.5 | 1.1 | Pass | Inventive |
| | | | | | | | | | | | | | | example |
| 15 | SUS316 | 50 | 50.0 | 0.5 | 5.0 | None | 4 | 0.1 | 0.2 | 7.0 | 7.5 | 1.1 | Pass | Inventive |
| | | | | | | | | | | | | | | example |
| 16 | SUS316 | 50 | 10.0 | 0.5 | 10.0 | None | 2 | <0.01 | 0.1 | 7.0 | 6.4 | 0.9 | Pass | Inventive |
| | | | | | | | | | | | | | | example |
| 17 | SUS316 | 50 | 10.0 | 2 | 2.0 | None | 2 | 0.03 | 0.1 | 7.0 | 6.2 | 0.9 | Pass | Inventive |
| | | | | | | | | | | | | | | example |
| 18 | SUS316 | 50 | 10.0 | 2 | 1.0 | None | 2 | 0.05 | 0.1 | 7.0 | 6.0 | 0.9 | Pass | Inventive |
| | | | | | | | | | | | | | | example |
| 19 | SUS316 | 50 | 10.0 | 0.5 | 20.0 | None | 7 | <0.01 | 0.1 | 6.5 | 7.5 | 1.2 | Pass | Inventive |
| | | | | | | | | | | | | | | example |
| 20 | SUS316 | 50 | 10.0 | 0.5 | 5.0 | None | 7 | <0.01 | 0.1 | 6.5 | 9.7 | 1.5 | Pass | Inventive |
| | | | | | | | | | | | | | | example |
| 21 | SUS316 | 300 | 10.0 | 0.2 | 5.0 | None | 1 | 0.2 | 0.2 | 7.0 | 5.5 | 0.8 | Pass | Inventive |
| | | | | | | | | | | | | | | example |
| 22 | SUS316 | 50 | 10.0 | 0.03 | 5.0 | 0.1 | 1 | <0.01 | 0.1 | 7.0 | 5.5 | 0.8 | Pass | Inventive |
| | | | | | | | | | | | | | | example |
| 23 | SUS316 | 50 | 10.0 | 0.5 | 5.0 | 3.0 | 3 | <0.01 | 0.1 | 7.0 | 7.1 | 1.0 | Pass | Inventive |
| | | | | | | | | | | | | | | example |
| 24 | SUS316 | 50 | 10.0 | 1 | 5.0 | 5.0 | 3 | <0.01 | 0.1 | 7.0 | 7.1 | 1.0 | Pass | Inventive |
| | | | | | | | | | | | | | | example |
| 25 | SUS316 | 50 | 5.0 | 3 | 1.0 | 5.0 | 3 | <0.01 | 0.1 | 7.0 | 7.1 | 1.0 | Pass | Inventive |
| | | | | | | | | | | | | | | example |
| 26 | SUS316 | 50 | 5.0 | 5 | 0.8 | 5.0 | 3 | <0.01 | 0.1 | 7.0 | 7.1 | 1.0 | Pass | Inventive |
| | | | | | | | | | | | | | | example |
| 27 | SUS304 | 50 | 5.0 | 5 | 0.8 | 5.0 | 3 | <0.01 | 0.1 | 7.0 | 7.1 | 1.0 | Pass | Inventive |
| | | | | | | | | | | | | | | example |
| 28 | SUS304 | 50 | 5.0 | 5 | 0.8 | 5.0 | 3 | <0.01 | 0.1 | 7.0 | 7.1 | 1.0 | Pass | Inventive |
| | | | | | | | | | | | | | | example |
| 29 | SUS310 | 50 | 5.0 | 5 | 0.8 | 5.0 | 3 | <0.01 | 0.1 | 7.0 | 7.1 | 1.0 | Pass | Inventive |
| | | | | | | | | | | | | | | example |
| 30 | SUS429 | 50 | 5.0 | 5 | 0.8 | 5.0 | 3 | <0.01 | 0.1 | 7.0 | 7.1 | 1.0 | Pass | Inventive |
| | | | | | | | | | | | | | | example |
| 31 | SUS429 | 50 | 5.0 | 5 | 0.8 | 5.0 | 3 | <0.01 | 0.1 | 7.0 | 7.1 | 1.0 | Pass | Inventive |
| | | | | | | | | | | | | | | example |

```
*1: Gas flow rate B; Gas flow rate B at the gas outlet of the center layer among three layers.
  Gas flow rate A; Gas flow rate A at the gas outlet of the remaining two side layers among three layers.
*2: R; Total width of all the layers combined at the gas outlet in the direction in which open pipe edges face each other.
  W; Maximum distance between end surfaces of portions to be welded directly below the gas outlet.
```

TABLE 2

| | | | | | | | | Oxygen | | | | | | |
|---|---|---|---|---|---|---|---|---|---|---|---|---|---|---|
| | | | | | | | | concen- | | | | | | |
| | | | | | | | | tration | | | | | | |
| | | | | Gas | | | | around | Results | Thick- | Thick- | | | |
| | | | Gas | flow | | | | portions | of | ness | ness | | Results of | |
| | | | flow | rate | | Reducing | | to be | flattening | of base | of | | corrosion | |
| | | Nozzle | rate B | ratio | | gas | Amount | welded | test on | metal | weld | | test on | |
| | Cladding | height | (m/s) | B/A | R/W | content | of upset | (mass | weld | tb | tw | | pipe inner | |
| Level | material | (mm) | *1 | *1 | *2 | (mass %) | (mm) | % × 10²) | h/D | (mm) | (mm) | tw/tb | surface | Remarks |
| 32 | SUS316 | 400 | 1.0 | 1 | 5.0 | None | 4 | 15 | 0.5 | 7.0 | 7.5 | 1.1 | Pass | Comparative |
| | | | | | | | | | | | | | | example |
| 33 | SUS316 | 100 | 0.4 | 1 | 5.0 | None | 4 | 160 | 0.8 | 7.0 | 7.5 | 1.1 | Pass | Comparative |
| | | | | | | | | | | | | | | example |
| 34 | SUS316 | 100 | 60.0 | 1 | 5.0 | None | 4 | 3 | 0.4 | 7.0 | 7.5 | 1.1 | Pass | Comparative |
| | | | | | | | | | | | | | | example |
| 35 | SUS316 | 400 | 60.0 | 1 | 5.0 | None | 4 | 40 | 0.6 | 7.0 | 7.5 | 1.1 | Pass | Comparative |
| | | | | | | | | | | | | | | example |
| 36 | SUS316 | 100 | 60.0 | 1 | 5.0 | 5.0 | 4 | 2 | 0.4 | 7.0 | 4.5 | 0.6 | Pass | Comparative |
| | | | | | | | | | | | | | | example |
| 37 | SUS316 | 400 | 1.0 | 1 | 5.0 | None | 10 | 12 | 0.4 | 7.0 | 7.5 | 1.1 | Rejection | Comparative |
| | | | | | | | | | | | | | | example |
| 38 | SUS304 | 400 | 60 | 1 | 5.0 | None | 4 | 40 | 0.6 | 7.0 | 7.5 | 1.1 | Pass | Comparative |
| | | | | | | | | | | | | | | example |
| 39 | SUS304 | 400 | 60 | 1 | 5.0 | None | 4 | 40 | 0.6 | 7.0 | 7.5 | 1.1 | Pass | Comparative |
| | | | | | | | | | | | | | | example |
| 40 | SUS310 | 400 | 60 | 1 | 5.0 | None | 4 | 40 | 0.6 | 7.0 | 7.5 | 1.1 | Pass | Comparative |
| | | | | | | | | | | | | | | example |
| 41 | SUS429 | 400 | 60 | 1 | 5.0 | None | 4 | 40 | 0.6 | 7.0 | 7.5 | 1.1 | Pass | Comparative |
| | | | | | | | | | | | | | | example |
| 42 | SUS429 | 400 | 60 | 1 | 5.0 | None | 4 | 40 | 0.6 | 7.0 | 7.5 | 1.1 | Pass | Comparative |
| | | | | | | | | | | | | | | example |

```
*1: Gas flow rate B; Gas flow rate B at the gas outlet of the center layer among three layers.
  Gas flow rate A; Gas flow rate A at the gas outlet of the remaining two side layers among three layers.
*2: R; Total width of all the layers combined at the gas outlet in the direction in which open pipe edges face each other.
  W; Maximum distance between end surfaces of portions to be welded directly below the gas outlet.
```

### REFERENCE SIGNS LIST

1 nozzle (shielding-gas blowing nozzle)

1A gas outlet

1C center layer

1E side layer

2 gas tube

3 gas controller

5 shielding gas

6 air entrainment

10 open pipe

11 portion to be welded (butting edge of open pipe)

12 heating starting point at edge of open pipe

13 welding paint

15 electric resistance welded steel pipe

20 pipe-length direction

30 open pipe circumferential direction

1. An electric resistance welded stainless clad steel pipe made of clad steel comprising low-carbon low-alloy steel and stainless steel, wherein the flattening characteristic of an electric resistance weld, as-welded, satisfies formula (1)-be-low:
h/D<0.3 (1)
wherein h is the flattened height at fracture (mm) and D is the outer diameter of the pipe (mm).

2. The electric resistance welded stainless clad steel pipe according to claim 1, wherein the thickness tw of the electric resistance weld satisfies the formula (2):
0.7×tb<tw<1.6×tb (2)
wherein tb is the thickness of base metal (mm) and tw is the thickness of the weld (mm).

3. A method of manufacturing the electric resistance welded stainless clad steel pipe according to claim 1, wherein a shielding process for portions of an open pipe to be welded for an electric resistance welded steel pipe is used to shield portions to be welded with a shielding gas composed of an inert gas during the electric resistance welding, the method comprising blowing the shielding gas to the portions to be welded through a gas outlet of a shielding-gas blowing nozzle which is divided into three layers in the open pipe circumferential direction, the gas outlet being disposed at a position 5 to 300 mm above the upper ends of the portions to be welded, wherein the gas flow rate B at the gas outlet of a center layer among the three layers is set to be 0.5 to 50 m/s, and the gas flow rate A (m/s) at the gas outlet of the remaining two side layers is set so as to satisfy formula (3):
0.01≤B/A≤10 (3)

4. The method of manufacturing the electric resistance welded stainless clad steel pipe according to claim 3, wherein the gas outlet is rectangular and has a length of 30 mm or more in a pipe-length direction and a width of 5 mm or more in a direction in which open pipe edges face each other.

5. The method of manufacturing the electric resistance welded stainless clad steel pipe according to claim 3, wherein the relationship R/W>1.0 is satisfied, wherein R is the total width of all the layers combined at the gas outlet in the direction in which open pipe edges face each other, and W is the maximum distance between end surfaces of the portions to be welded directly below the gas outlet.

6. The method of manufacturing the electric resistance welded stainless clad steel pipe according to claim 3, wherein the inert gas is replaced by a gas containing 0.1% by mass or more of a reducing gas.

7. A method of manufacturing the electric resistance welded stainless clad steel pipe according to claim 2, wherein a shielding process for portions of an open pipe to be welded for an electric-resistance-welded steel pipe is used to shield portions to be welded with a shielding gas composed of an inert gas during the electric resistance welding, the method comprising blowing the shielding gas to the portions to be welded through a gas outlet of a shielding-gas blowing nozzle which is divided into three layers in the open pipe circumferential direction, the gas outlet being disposed at a position 5 to 300 mm above the upper ends of the portions to be welded, wherein the gas flow rate B at the gas outlet of a center layer among the three layers is set to be 0.5 to 50 m/s, and the gas flow rate A (m/s) at the gas outlet of the remaining two side layers is set so as to satisfy formula (3):
0.01≤B/A≤10 (3)

8. The method of manufacturing the electric resistance welded stainless clad steel pipe according to claim 7, wherein the gas outlet is rectangular and has a length of 30 mm or more in a pipe-length direction and a width of 5 mm or more in a direction in which open pipe edges face each other.

9. The method of manufacturing the electric resistance welded stainless clad steel pipe according to claim 7, wherein the relationship R/W>1.0 is satisfied, wherein R is the total width of all the layers combined at the gas outlet in the direction in which open pipe edges face each other, and W is the maximum distance between end surfaces of the portions to be welded directly below the gas outlet.

10. The method of manufacturing the electric resistance welded stainless clad steel pipe according to claim 4, wherein the relationship R/W>1.0 is satisfied, wherein R is the total width of all the layers combined at the gas outlet in the direction in which open pipe edges face each other, and W is the maximum distance between end surfaces of the portions to be welded directly below the gas outlet.

11. The method of manufacturing the electric resistance welded stainless clad steel pipe according to claim 8, wherein the relationship R/W>1.0 is satisfied, wherein R is the total width of all the layers combined at the gas outlet in the direction in which open pipe edges face each other, and W is the maximum distance between end surfaces of the portions to be welded directly below the gas outlet.

12. The method of manufacturing the electric resistance welded stainless clad steel pipe according to claim 7, wherein the inert gas is replaced by a gas containing 0.1% by mass or more of a reducing gas.

13. The method of manufacturing the electric resistance welded stainless clad steel pipe according to claim 4, wherein the inert gas is replaced by a gas containing 0.1% by mass or more of a reducing gas.

14. The method of manufacturing the electric resistance welded stainless clad steel pipe according to claim 8, wherein the inert gas is replaced by a gas containing 0.1% by mass or more of a reducing gas.

15. The method of manufacturing the electric resistance welded stainless clad steel pipe according to claim 5, wherein the inert gas is replaced by a gas containing 0.1% by mass or more of a reducing gas.

16. The method of manufacturing the electric resistance welded stainless clad steel pipe according to claim 9, wherein the inert gas is replaced by a gas containing 0.1% by mass or more of a reducing gas.

17. The method of manufacturing the electric resistance welded stainless clad steel pipe according to claim 10, wherein the inert gas is replaced by a gas containing 0.1% by mass or more of a reducing gas.

18. The method of manufacturing the electric resistance welded stainless clad steel pipe according to claim 11, wherein the inert gas is replaced by a gas containing 0.1% by mass or more of a reducing gas.
